(19) United States
(12) Patent Application Publication
(10) Pub. No.: US 2011/0084510 A1
(43) Pub. Date: Apr. 14, 2011

(54) Connections for joining accessories to vehicle cargo sockets

(76) Inventor: Leland D. Marean, Tulelake, CA (US)

(21) Appl. No.: 12/587,639

(22) Filed: Oct. 8, 2009

(51) Int. Cl. B62D 27/00

(52) U.S. Cl. 296/36

(57) ABSTRACT

A collection of different sets of apparatus for holding vehicle accessories and joining them to differently configured vehicle cargo sockets. Due to the diversity of extant cargo socket constructions, even within a single vehicle, no single set of apparatus suffices to join an accessory to a socket. Therefore, to serve the singular purpose of joining an accessory to a vehicle cargo socket, multiple different connections are required.

The difficulty of providing accessory connections is further exacerbated by the fact that socket constructions change from manufacturer to manufacturer; from model to model; and from year to year. Therefore, a collection of different sets of connections is required. Otherwise, an ongoing multitude of patents would be required to satisfy a single purpose.

Thus, the present invention is a collection of different sets of apparatus, all having a singular purpose of joining accessories to vehicles.

### BACKGROUND

### Field of Invention

This invention relates to a collection of sets of different apparatus for joining accessories to vehicle cargo sockets, especially wherein some sockets have different configurations, even within a specific vehicle.

### BACKGROUND

### Description of Prior Art

Rack and stake systems for enhancing cargo carrying capacity of land vehicles began with wooden wagons usually pulled by draft animals. Such wagons were often fitted with sockets fastened along the tops of vehicle boxes or beds for easy installation of spreading rack structures, stakes, seating, side boards, canopies, etc. The accessories usually included upright mounting posts, stakes, or similar members, which were placed into the sockets during accessory use to enhance wagon utility.

After the invention of motorized trucks, similar sockets were provided in some trucks. Sockets were provided along the edges of some flat bed trucks, for example, for installation of accessory stakes or rack structures similar to those of wagons. Pickup trucks, on the other hand, for the most part have always been manufactured with sockets along the tops of their box sides; however, no pickup truck manufacturer provides accessory structures for fastening to these sockets which enhances cargo capacity. Therefore, pickup truck owners desirous of hauling bulky or unwieldy cargo, for example, are left to their own devices, usually by driving wooden stakes into the socket openings, to which horizontal boards are fastened, in a similar manner as was done with wagons. A serious shortcoming to this arrangement is that in many trucks there is no substantial way of fastening accessories to truck box sockets.

Such makeshift racks, posts or other accessory structures are not stable, durable or safe. However, truck owners have had no other choice for fastening accessories to pickup truck beds or boxes, because truck manufacturers provide no means for substantially fastening racks or similar accessories to their truck sockets. Furthermore, truck manufacturers have no standard configuration for box sockets, and each manufacturer's truck sockets are designed differently from all others. Also, truck manufacturers have differently configured sockets on each model they produce, and which change with each new model. Worse, a specific truck model typically has different specifications for the sockets within a specific box. As a result, an individual who fabricates his own racks or other box mountable accessories will likely have to construct another system with each new vehicle purchase. Thus, no manufacturer provides sockets designed for expeditious and safe utilization by an individual vehicle owner. While pickup truck box sockets are the most common type, accessory mounting sockets may also be provided on other types of trucks, and other vehicles such as trailers, wagons, carts, watercraft, etc.

As a result of the foregoing, there is no prior art which is relevant to my invention.

### OBJECTS AND ADVANTAGES

Accordingly, besides the objects and advantages of the accessory mounting assemblies described in my above patent, several objects and advantages of the present invention are:
(a) to provide an accessory connector which can be installed on a vehicle so as to safely and securely fasten an object, or accessory, to a vehicle socket;
(b) to provide an accessory joining assembly for installation inside integral vehicle body sockets;
(c) to provide an accessory connector which is stable and rigid;
(d) to provide an accessory joining assembly which is unaffected by weather;
(e) to provide a joining assembly capable of holding an accessory support member inside a socket, wherein the socket cavity is wider than the vehicle body sheathing access opening to the socket;
(f) to provide an accessory connector such that clamping pressure for holding an accessory can be regulated from outside a socket access opening;
(g) to provide a vehicle accessory joining assembly which can be incrementally assembled through a vehicle body sheathing socket access opening;
(h) to provide an accessory receptacle and fastening system having minimal components;
(i) to provide an accessory member clamping system utilizing screw operated clamping components;
(j) to provide accessory joining components which are adaptable to different socket designs;
(k) to provide an accessory joining assembly which can be used for different cargo hauling accessories, such as those for hauling carrying livestock, firewood, tools, lumber, bulky loads, etc.
(l) to provide a joining assembly requiring minimal maintenance;
(m) to provide connections between vehicle cargo sockets and accessories which enhances the value of a vehicle;
(n) to provide a collection of devices from which to choose for joining accessories to vehicles having differently configured and constructed sockets;
(o) to provide connections between accessories and vehicle sockets having uncertain dimensions.

Further objects and advantages are to provide an accessory joining assembly which is easily shipped and easily installed by a vehicle owner. Still further objects and advantages will become apparent from a consideration of the ensuing description and drawings.

### DRAWING FIGURES

In the drawings, closely related figures have the same number but different alphabetic suffixes.

FIG. 1 is a cutaway view showing a set of screw operated clamping apparatus for fastening an accessory in a vehicle cargo socket.

FIG. 1A is a detail view of a clamping plate with two beveled faces which cooperate with beveled faces of other components of a set of apparatus to provide clamping pressure.

FIG. 1B is a detail view of a screw operated top slidable clamping dog with a beveled face which slides against a beveled face of the clamping plate, to provide clamping pressure.

FIG. 1C is a detail view of a screw operated bottom slidable clamping dog with a beveled face which slides against a beveled face of the clamping plate, to provide clamping pressure.

FIG. 2 is a cutaway view showing a set of screw operated clamping apparatus for fastening an accessory in a vehicle cargo socket.

FIG. 2A is a detail view of a clamping plate with a lower beveled face which cooperates with a slidable clamping dog beveled face to provide clamping pressure.

FIG. 2B is a detail view of a screw operated slidable clamping dog, with a beveled face which cooperates with a beveled face on the clamping plate, to provide clamping pressure.

FIG. 2C is a detail view of a shoe with depressions in its top which supportively positions the ends of clamping screws within a vehicle socket bottom.

FIG. 3 is a cutaway view of vehicle outer body sheathing and an internal integral socket, with a receptacle and keeper for holding an accessory in the socket, and the receptacle fastened to an adapter for fastening to the vehicle.

FIG. 3A is a detail view of a connective adapter plate of uncertain form with holes for fastening a receptacle to a vehicle socket of uncertain dimensions.

FIG. 3B shows an adapter backing plate of uncertain form with a fastening hole, for strengthening accessory holding assembly connections to socket walls of uncertain form.

FIG. 4 is a cutaway view of vehicle outer body sheathing and an internal integral socket, with a receptacle and keeper for holding an accessory in the socket, and the receptacle fastened to an adapter for joining to the vehicle.

FIG. 4A shows a connective adapter plate of uncertain form with holes for fastening a receptacle to a vehicle socket of uncertain dimensions.

FIG. 4B shows an adapter backing plate of uncertain form with fastening holes, for strengthening connections to socket walls of uncertain dimensions.

FIG. 5 is a detail view of a receptacle for holding an accessory in a vertical void through it, and two holes for fastening it to an adapter.

FIG. 5A is a detail view of a keeper for snug placement in a socket bottom and into which an accessory bottom end is inserted to eliminate its lateral movement in the socket bottom.

FIG. 6 shows an accessory receptacle with a screw actuated clamping mechanism, similar to that of FIGS. 1, 1A, 1B, 1C, for clamping an accessory.

FIG. 7 is an exploded view of an accessory holding receptacle with a U-shaped yoke and screws for clamping the accessory to the receptacle.

FIG. 7A is an opposite end view of a similar yoke to that shown in FIG. 7, showing threaded fastening holes for clamping an accessory to the receptacle.

FIG. 8 is an exploded view of an accessory connecting assembly with slidable, interlocking receptacle and adapter plate.

FIG. 9 is a partial view of an adapter with broken lines along its back side to illustrate that the back side may be any shape required for a specific socket.

FIG. 10 shows an accessory connecting assembly similar to that of FIG. 8, except that its longitudinal void also contains clamping components similar to those of FIG. 1, for fastening an accessory to the receptacle.

FIG. 11 is an exploded view of a tubular receptacle for holding an accessory in a socket.

FIG. 12 is an exploded view of a tubular receptacle with a projection and fastening hole, for holding an accessory and fastening it to a socket.

FIG. 12A is a solid accessory holder with a projection and fastening hole, and with a keeper around its bottom for certain lateral disposition in a socket bottom, for joining an accessory to a vehicle.

FIG. 12B is a solid accessory holder similar to FIG. 12A, but configured with a cylindrical vertical projection on its bottom end for certain lateral disposition in a socket bottom configured with a hole.

FIG. 13 shows an accessory holder with a cylindrical projection on its bottom end, similar to that of FIG. 12B.

FIG. 13A is similar to FIG. 13, but without the threaded mounting hole.

FIG. 13B shows a solid accessory holder similar to that of FIG. 13, but with a U-shaped keeper for maintaining its lateral position in a socket bottom.

FIG. 14 is an exploded view of an adjustable assembly for joining an accessory to a vehicle socket.

FIG. 14A is an exploded view of another adjustable assembly for joining an accessory to a vehicle socket.

### REFERENCE NUMERALS IN DRAWINGS

| | | | |
|---|---|---|---|
| 1 | Vehicle outer sheathing metal | 30 | Clamp screw |
| 2 | Integral socket | 31 | Bolt |
| 3 | Receptacle | 32 | Screw |
| 4 | Clamping receptacle | 34 | Yoke screw |
| 5 | Interlocking receptacle | 35 | Screw |
| 6 | Clamping interlocking receptacle | 36 | Screw |
| 10 | Adapter plate | 40 | Receptacle |
| 11 | Double clamping plate | 41 | Shoe |
| 12 | Single clamping plate | 42 | Keeper |
| 13 | Single hole adapter | 43 | Yoke |
| 14 | Multi-hole adapter | 44 | Disc |
| 15 | Simple backing plate | 45 | Insert |
| 16 | Complex backing plate | 46 | Connector |
| 17 | Interlocking adapter | 47 | Receptacle |
| 20 | Bottom slidable dog | 47 | Receptacle |
| 21 | Top slidable dog | 48 | Connector |
| 22 | Single slidable dog | 49 | Receptacle |
| 23 | Accessory | 50 | Receptacle |
| | | 51 | Receptacle |
| | | 52 | Adjustable receptacle |
| | | 53 | Adjustable stay |
| | | 54 | U-holder |

### SUMMARY

In accordance with the present invention a collection of different mechanical connective assemblies for joining accessories to differently configured vehicle sockets.

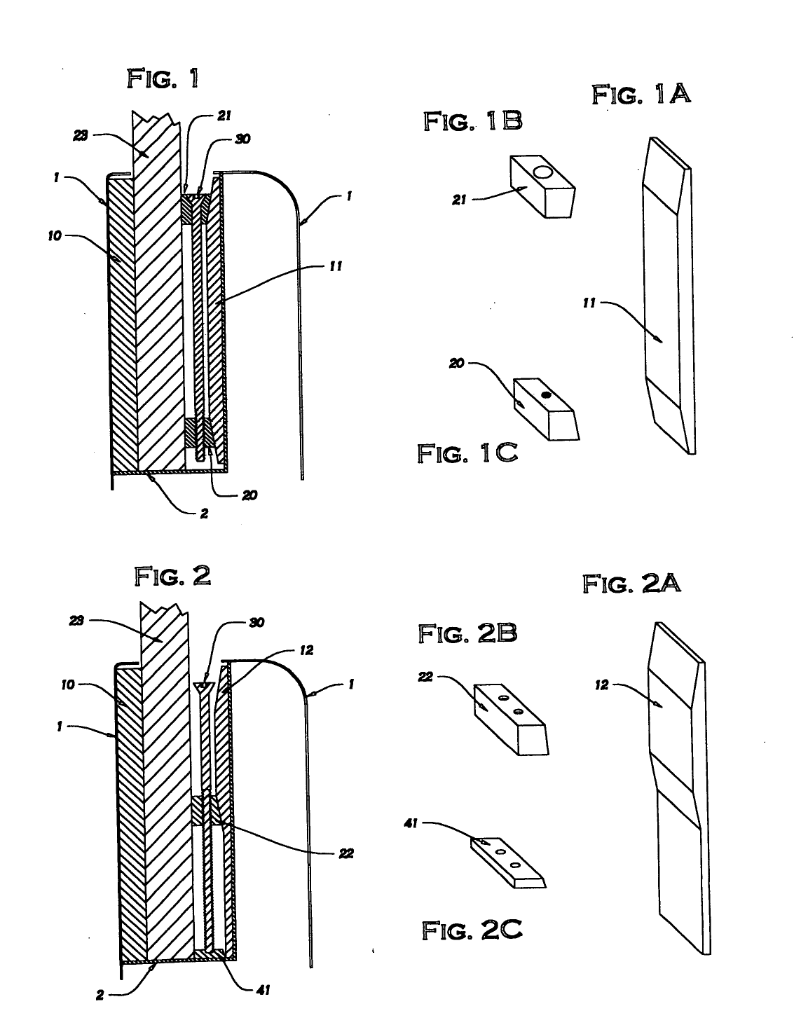

### Description—FIG. 1

FIG. 1 is a preferred embodiment of a connective assembly for joining an accessory to a vehicle socket 2. Shown is a cutaway view of a vehicle outer body sheathing metal 1 including an integral sheet metal socket 2, holding an accessory 23 inside a receptacle cavity formed on one side by an adapter plate 10. Adapter 10 fills a void within the socket 2 cavity between the accessory 23 and the socket 2 cavity wall so that accessory 23 will not touch body 1 above the cavity of socket 2. A screw 30 smooth shank and head cooperate with a countersunk hole through a top slidable dog 21 and threads of the screw 30 cooperate with threads in a bottom slidable dog 20, therefore drawing slidable dog 20 and slidable dog 21 toward one another during operation of the screw 30. Within the confines of socket 2, beveled faces on both slidable dogs 20 and 21 cooperate with respective beveled faces on an adjacent double clamping plate 11 during operation of the screw 30 which forces slidable dogs 20 and 21 away from the plate 11. Thereby, dogs' 20 and 21 vertical faces urge against accessory 23 within the confines of socket 2, thus locking accessory 23 inside of socket 2. Although not shown, accessory 23 may be configured with a cylindrical pin protruding from its bottom end and inserted through a hole in vehicles fitted with a hole in the bottom of socket 2 to eliminate lateral movement of the accessory 23 bottom. Not shown, a keeper 42 may alternatively be installed in the bottom of the socket 2 to eliminate lateral movement of the accessory 23 bottom.

While the present invention embodiment of FIG. 1 is shown oriented one selected way with respect to vehicle body sheathing 1, it may be otherwise oriented in any functional way.

### Description—FIG. 1A

FIG. 1A shows a double clamping plate 11 configured with beveled faces on each end of one side. These beveled faces cooperate with respective beveled faces on slidable dogs 20 and 21 during operation of a screw 30 to force slidable dogs 20 and 21 vertical surfaces against an accessory 23, and thereby forcing it against an adapter plate 10 which locks all members together, inside the confines of the socket 2.

### Description—FIGS. 1B, 1C

FIGS. 1B, 1C show slidable dogs 20 and 21 with vertical holes through each and each with one vertical side and one beveled side. The hole through dog 21 is shown countersunk and smooth, to cooperate with a screw 30 smooth portions, whereas the hole through dog 20 is threaded to cooperate with threads of the clamping screw 30.

### Description—FIG. 2

FIG. 2 is a typical embodiment of a connective assembly for joining an accessory to a vehicle socket 2. A slidable dog 22 has one vertical surface shown flush against an accessory 23 and one beveled surface flush against a clamping plate 12 beveled face with which it cooperates during operation of two clamping screws 30. Recesses in the top side of a shoe 41 hold the bottom ends of the screws 30. While this embodiment of the present invention is shown in one selected orientation with respect to body 1, it may be otherwise oriented in any functional way.

### Description—FIGS. 2A, 2B, 2C

FIG. 2A shows single clamping plate 12 which is configured with a beveled face about midway on one side and another toward the top of the same side. FIG. 2B shows a slidable dog 22 with two vertical, threaded holes cooperate with threads of two clamping screws 30. One face of dog 22 is vertical, and the opposite side is beveled to slidably cooperate with the adjacent beveled face of plate 22. FIG. 2C shows a flat shoe 41 with two cylindrical recesses in its top side to cooperate with the respective bottom ends of clamping screws 30 to maintain their lateral disposition in the bottom of a socket 2. A beveled side of shoe 41 facilitates installation of components into a socket 2.

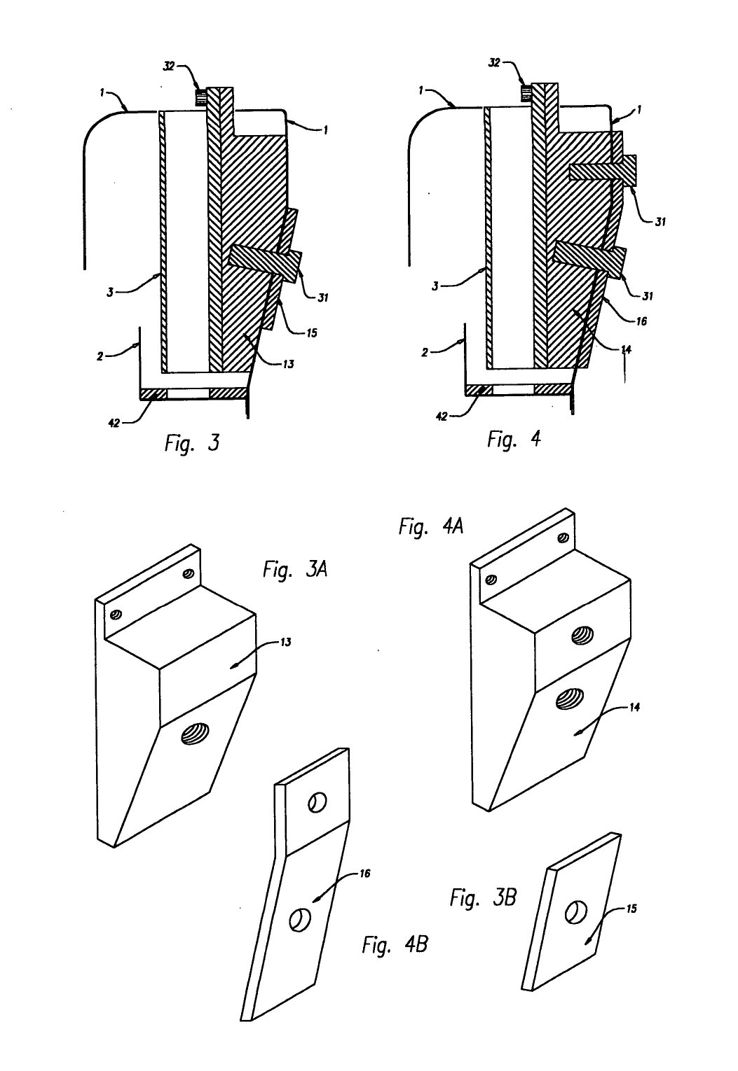

### Description—FIG. 3

FIG. 3 shows a cutaway view of a preferred embodiment of a connective assembly for joining an accessory to a vehicle socket 2. A receptacle 3 is shown, with a vertical void for holding an accessory, and is fastened through its flange with screws 32 and to an adapter plate 13. The adapter 13 is fastened by a threaded hole to socket 2, and/or alternatively body 1, with a fastening bolt 31 placed through a backing plate 15, which strengthens the sheet metal connection. Adapter 13 is shown having a certain configuration on its side fastened to socket 2, but the configuration in practice may be any so as to provide adequately rigid connection with socket 2. Enclosed within the bottom of socket 2 is an optional substantially rectangular keeper 42 with a hole through it for insertion of an accessory bottom end so as to certainly dispose the accessory end within the socket 2 bottom. While the present invention embodiment is shown in FIG. 3 in one orientation with respect to vehicle socket 2, it may be otherwise oriented in any functional way.

### Description—FIGS. 3A, 3B

FIG. 3A is a detail view of an adapter plate 13 having two threaded holes through its top flange for fastening to a receptacle. A threaded hole is shown in its beveled face for fastening to a socket 2. FIG. 3B shows a flat backing plate 15 with a bolt 31 fastening hole through its center for increasing strength of connections through sockets 2 and/or vehicle body sheathing 1.

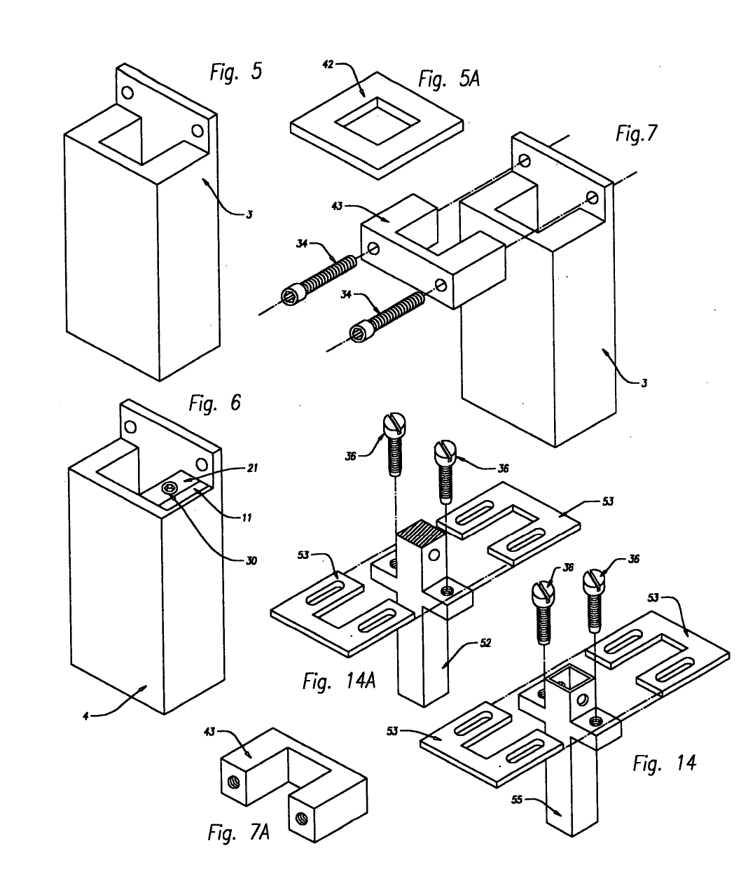

### Description—FIG. 4

FIG. 4 is cutaway view of a preferred embodiment of an assembly for fastening an accessory to a vehicle socket 2. A receptacle 3 is shown, with a vertical void through it for holding an accessory, with screws 32 fastened through holes in a flange along it top. Receptacle 3 is fastened flush to an adapter plate 14, having threaded fastening holes through a flange along its top. Adapter 14 threaded holes for fastening to a socket 2 are shown on its curved side. Bolts 31 fasten through a curved backing plate 16 into the threaded mounting holes in adapter 14, thereby sandwiching socket 2 between adapter 14 and plate 16 for increased connection strength. An optional keeper 42 is shown firmly held in the bottom of socket 2 for insertion of an accessory bottom end, which provides certain disposition of an accessory within the bottom of socket 2. While the present invention embodiment is shown in FIG. 4 in one orientation with respect to vehicle socket 2, it may be otherwise oriented in any functional way.

### Description—FIGS. 4A, 4B

FIG. 4A shows a detail view of an adapter 14 with two threaded fastening holes through its top flange for fastening to a receptacle 3. Two threaded mounting holes are shown in its curved side for fastening of adapter 14 to a vehicle socket. FIG. 4B is a detail view of a backing plate 16 with two holes for fastening to a member within a socket 2 and sandwiching the socket 2 wall between the two for strengthening the entire connection. While plate 16 is shown in a selected configuration, it may be any whatsoever required for joining any accessory to any socket 2.

### Description—FIGS. 5, 5A

FIG. 5 is a detail view of a typical receptacle 3, which has a vertical void through it for holding and accessory. Receptacle 3 has two mounting holes through a top flange for fastening to an adapter. FIG. 5A is a detail view of a flat, substantially rectangular keeper 42 with a receiving hole though it. Its peripheral dimensions are such that it will fit snugly in the bottom of a socket 2, and its hole snugly accepts insertion of an accessory bottom end to secure it laterally within a socket 2. It may be configured to secure any bottom end of any accessory or accessory receptacle within a socket 2.

### Description—FIG. 6

FIG. 6 is a preferred embodiment detail view of a receptacle 4 for holding an accessory within a socket 2. Receptacle 4 has a vertical void for inserting and holding an accessory. This view shows installed in receptacle 4 a top slidable dog 21, a clamping screw 30 and a clamping plate 11, which cooperate with an unseen bottom slidable dog 20, whose operation is described in FIG. 1.

### Description—FIGS. 7, 7A

FIG. 7 is an exploded view of a preferred embodiment of a receptacle 3, with a vertical void for holding an accessory, the same as FIG. 5. A yoke 43 with fastening screws 34 provide clamping force on an accessory held in the void of receptacle 3. FIG. 7A shows another embodiment of yoke 43 in reverse position to show threaded fastening holes for screws 34 when placed through receptacle 3 from the opposite direction shown in FIG. 7.

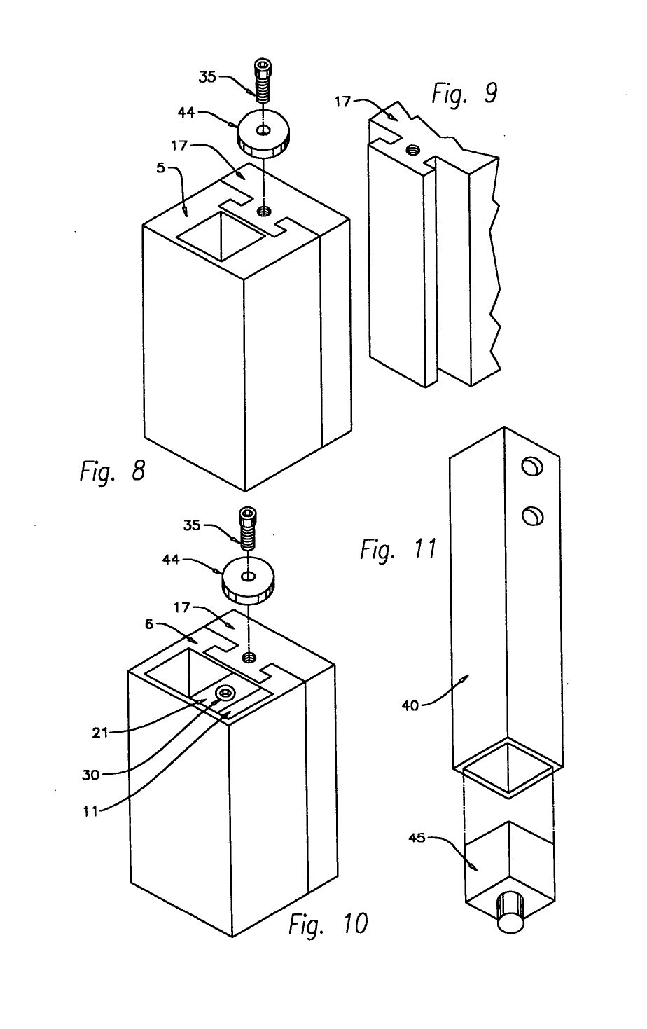

### Description—FIGS. 8, 9

FIG. 8 is a partially exploded view of a preferred embodiment of an assembly for joining an accessory to a vehicle socket 2. A vertical void through a receptacle 5 is for holding accessories. Receptacle 5 is configured with slidable, vertical ways which interlock with those of an adapter 17. A locking disc 44 is fastened to the adapter 17 with a screw 35 to prohibit receptacle 5 from vertical movement with respect to adapter plate 17. While the back side of the adapter 17 appears flat, it may be any shape required to provide full contact with any socket 2. FIG. 9 is a detail view of adapter 17 showing a broken line back side to indicate the back side may be configured as required to conform to any shape of a socket 2 interior. Not shown is threaded mounting hole(s) in the back side of adapter 17 for fastening to any socket 2.

### Description—FIG. 10

FIG. 10 is a preferred embodiment of an assembly for fastening an accessory to a vehicle socket 2, similar to FIG. 9 except that the receptacle 6 vertical void for holding an accessory is enlarged to also contain a top slidable dog 21, screw 30, plate 11, and unseen bottom slidable dog 20, as described in FIG. 1, for clamping an accessory inside the void of receptacle 6. Receptacle 6 is configured with slidable, vertical ways which interlock with those of adapter 17. A screw 35 through a hole in a disc 44 is fastened into a threaded hole in the top of adapter 17 to lock adapter 17 and receptacle 6 together, vertically. The back side of adapter 17 may be any configuration whatsoever to make secure contact and fastening with any configuration of any socket 2. Therefore, after fastening adapter 17 within a socket 2, receptacle 6 vertical, interlocking ways may be slid vertically through a socket 2 access opening, vertically interlocking with those of adapter 17. After fastening together receptacle 6 and adapter 17 with screw 35 and disc 44, and clamping an accessory in receptacle 6, an accessory will be fastened in a vehicle socket 2.

### Description—FIG. 11

FIG. 11 is an exploded view of a typical embodiment of an assembly for holding and joining an accessory to a vehicle socket. An insert 45 with a downward facing cylindrical projection is for insertion inside the bottom of tubular receptacle 40, and the projection inserts through a hole through the bottom of a socket 2, for lateral locking of receptacle 40 within the bottom of socket 2. Two holes toward the top of tube 40 are for fastening an accessory, thereby fastening an accessory to a vehicle. The present invention includes the apparatus shown in FIG. 11 configured as being an integral part of a vehicle accessory.

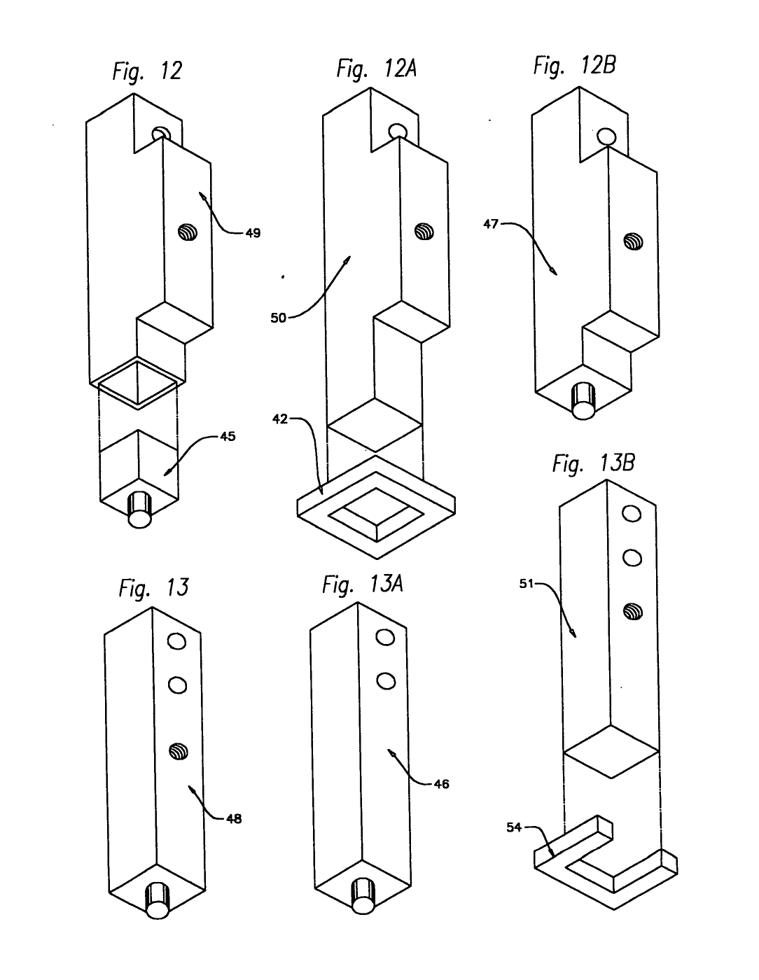

### Description—FIG. 12

FIG. 12 is an exploded view of a preferred embodiment of an assembly for fastening an accessory to a vehicle socket 2. A receptacle 49 body is shown with a vertical void through it for holding an accessory. An adaptive insert 45 pressed into the bottom end of receptacle 49 void has a cylindrical, vertical projection which fastens through sockets 2 which are provided with holes in their bottoms, for lateral locking of the receptacle 49 in the bottom of sockets 2. Receptacle 49 is configured with a projection on one side with a threaded mounting hole through it, and a hole in its upper end for fastening an accessory, whereby the accessory will be fastened to a vehicle. Whereas the projection face is shown flat, it may be any shape whatsoever to conform to a wall of a socket 2. Alternatively, the projecting portion may be a separate adapter plate, configured to enhance installation in certain configurations of sockets 2. The present invention includes the apparatus shown in FIG. 12 configured as being an integral part of a vehicle accessory.

### Description—FIG. 12A

FIG. 12A is an exploded view of a preferred embodiment of an assembly for joining an accessory to a vehicle socket 2. A receptacle 50 is shown for with a top hole for holding an accessory, and having a projection on one side with a threaded mounting hole through it for fastening to the wall of a socket 2. Whereas the projection face is shown flat, it may be any shape whatsoever to conform to the shape of any wall of a socket 2. Alternatively, the projecting portion may be a separate adapter plate configured to provide for installation in certain configurations of sockets 2. At the bottom of receptacle 50 is an adapting keeper 42 which is for snug placement in the bottom of a socket 2. The adapting keeper 42 has a hole through it for snug insertion of the receptacle 50 body bottom end for certain disposition of receptacle 50 in the bottom of the socket 2. The top of receptacle 50 has a hole through it for possible fastening of an accessory, whereby an accessory will be fastened to a vehicle. The present invention includes the apparatus shown in FIG. 12A configured as being an integral part of a vehicle accessory.

### Description—FIG. 12B

FIG. 12B is a preferred embodiment of a connector for holding and joining an accessory to a vehicle socket 2. A receptacle 47 is shown having a projection on one side with a threaded mounting hole through it for fastening to the wall of a socket 2. Whereas the projection face is shown flat, it may be any shape whatsoever as required to conform to the shape of any socket 2 wall. Alternatively, the projecting portion may be a separate adapter plate to provide for installation of receptacle 47 in certain configurations of sockets 2. The bottom end of receptacle 47 has a cylindrical projection for snug insertion through a hole in the bottom of a socket 2, to laterally lock the receptacle 47 bottom in the bottom of a socket 2. A hole in the top of receptacle 47 is for fastening an accessory, after which the accessory will be fastened to a vehicle. The present invention includes the apparatus shown in FIG. 12B configured as being an integral part of a vehicle accessory.

### Description—FIGS. 13, 13A, 13B

FIG. 13 is a typical embodiment of a connective receptacle 48 for joining an accessory to a vehicle socket 2. A threaded hole is shown in one side for mounting to the wall of a socket 2, and holes toward its upper end are for fastening an accessory to receptacle 48. A cylindrical vertical projection from the bottom of receptacle 48 is for insertion through a hole in the bottom of a socket 2, for certain lateral disposition, after which an accessory will be fastened to a vehicle.

FIG. 13A shows a typical embodiment of a connective receptacle 46 for holding and joining an accessory to a vehicle socket 2. Receptacle 46 gains rigidity from a bottom cylindrical, vertical projection being inserted through a hole in the bottom of a socket 2, and from fastening with a rigid accessory through two upper holes, after which an accessory will be fastened to a vehicle.

FIG. 13B is a typical embodiment of an assembly for holding and joining an accessory to a vehicle socket 2. A receptacle 50 has a threaded mounting hole in one side for fastening to the wall of a socket 2. The bottom end is certainly disposed within the bottom of a socket 2 by a U-shaped adaptive keeper 54, which is snugly set within the bottom of a socket 2, and the receptacle 51 bottom is snugly seated within the three-sided keeper 54 opening. Holes in the top of receptacle 51 are for fastening an accessory, thereby fastening the accessory to a vehicle. The present invention includes the apparatus shown in FIGS. 13, 13A and 13B configured as each being an integral part of vehicle accessories.

### Description—FIG. 14

FIG. 14 is an exploded view of a preferred embodiment of an adjustable assembly for joining an accessory to a vehicle socket. A cruciform receptacle 55 has a hollow vertical portion for holding an accessory fastened to a hole through the top of receptacle 55, and two opposed lateral projections have vertically threaded holes through both. Adaptive stays 53 are flat, U-shaped elements configured with elongated fastening holes along each of two legs, for fastening with screws 36 to the threaded holes in the receptacle 55 projections. When fastened, one stay 53 lies atop the other such that screws 36 pass though respective elongated holes of both for fastening into respective threaded holes in the receptacle 55. Adjustable stays 53 elongated holes provide for adjustment of stays 53 toward and away from receptacle 55, as required to fasten receptacle 55 within a vehicle socket 2 by causing the distal ends of stays 53 to urge against opposite walls of any socket 2. While not shown, receptacle 55 may be fitted with an insert 45 for certain disposition within the bottom of a socket 2. Alternatively, it may be supplied with a keeper 42 or 54 for certain disposition within the bottom of a socket 2, as described in FIGS. 12A and 13B respectively, depending on the specific socket 2 configuration. Thus, an accessory may be fastened to a vehicle. The present invention includes the apparatus shown in FIG. 14 configured as being an integral part of a vehicle accessory.

### Description—FIG. 14A

FIG. 14A is an exploded view of a preferred embodiment of an adjustable assembly for joining an accessory to a vehicle socket 2. A solid cruciform receptacle 52 is configured with opposed horizontal projections, each with a vertical threaded fastening hole. Two mutually overlapping, U-shaped adjustable stays 53 are shown with an elongated fastening hole in each leg. Each adaptive stay 53 is adjustably fastened to receptacle 52 with screws 36 such that the distal ends of stays 53 urge against opposite sides of a socket 2 for upright fastening of receptacle 52 within a socket 2. While not shown, the bottom end of receptacle 52 may be configured with a cylindrical vertical projection for fastening in the bottom of sockets 2 configured with a hole through their bottoms, for certain disposition of the receptacle 52 in the socket 2 bottom. Alternatively, receptacle 52 may be provided with an adaptive keeper 42 or 54 for certain disposition within a socket 2 bottom, as described in FIGS. 12A and 13B, respectively, depending on the specific socket 2 configuration. A hole toward the top of receptacle 52 is for fastening an accessory, after which it will be fastened to a vehicle. The present invention includes the apparatus shown in FIG. 14A configured as being an integral part of a vehicle accessory.

### Operation—FIGS. 1, 1A, 1B, 1C

FIG. 1 is a cutaway view of a vehicle outer body sheathing 1 with an integral socket 2 and an accessory 23 clamped within a receptacle. An adapter plate 10 is shown flat against a socket 2 wall, although that side of adapter 10 may be any shape necessary, depending on vehicle design, to provide adequate surface area contact with any socket 2 wall of any surface form. Accessory 23 is in flush contact with respective vertical sides of a top slidable dog 21 and a bottom slidable dog 20. A shank and head of clamping screw 30 is shown cooperating vertically through a countersunk, smooth hole through the dog 21, and threads of the screw 30 cooperating with a vertically threaded hole through the dog 20. Dogs 20 and 21 have beveled sides in flush contact with respective beveled faces of a double clamping plate 11. The opposite side of plate 11 is shown flat against a wall of the socket 2, but may be any configuration necessary to make supportive contact with any socket 2 wall.

With an accessory 23 inside the receptacle cavity and during operation of the screw 30, dogs 20 and 21 will be caused to move toward one another and away from the plate 11 and therefore forced against the accessory 23, due to cooperation between the beveled faces of the dogs 20 and 21 and respective beveled faces of the plate 11. Thus, adapter 10, accessory 23, slidable dogs 20 and 21, and clamping plate 11 will be forced together within the confines of a socket 2 during operation of the screw 30.

FIG. 1A double clamping plate 11 has one upper and one lower beveled surface which correspond to respective beveled faces of the adjacent FIG. 1B top slidable dog 21 and FIG. 1C bottom slidable dog 20. FIG. 1B shows a top slidable dog with a recessed smooth hole which cooperates with a screw 30 head and shank. FIG. 1C bottom slidable dog 20 has a threaded hole through it which cooperates with threads of screw 30. The proportions of all parts are such that they may be assembled and operated through the socket 2 access opening, including the space shown between the bottom end of screw 30 and the bottom of the socket 2. Therefore, by operation of the screw 30, it cooperates with dogs 20 and 21 to draw them toward one another and cause their beveled faces to slide over respective beveled faces of plate 11 and thus drive them away from plate 11, such that internal force is caused within the confines of socket 2, thereby clamping together adapter 10, accessory 23, dogs 20 and 21, and plate 11 to socket 2. Thus, accessory 23 is fastened inside socket 2.

While FIG. 1 shows parts oriented one way with respect to vehicle sheet metal 1, they may be otherwise oriented in any functional way. The present invention includes the apparatus shown in FIG. 1 to include the accessory 23 being instead a receptacle, similar to that of a receptacle 40.

### Operation—FIGS. 2, 2A, 2B, 2C

FIG. 2 is a cutaway view of an assembly for fastening an accessory inside a vehicle socket 2. Operation of one or more screw(s) 30 causes the beveled face of dog 22 to slide along the adjacent beveled face of clamping plate 12, because the bottom ends of screws 30 are held in place within the recesses in the top of shoe 41, and thus causes dog 22 to move upward and away from plate 12. Thus, the vertical face of dog 22 is forced against accessory 23. Within the confines of socket 2, operation of screws 30 therefore forces plate 10, accessory 23, dog 22 and plate 12 together, thus clamping assessor 23 inside socket 2.

FIG. 2A single locking plate 12 is shown with a lower beveled face which cooperates with an adjacent beveled face on FIG. 2B single slidable dog 22. Dog 22 is shown with two threaded through holes which cooperate with threads of two screws 30. The bottom ends of screws 30 are supported by respective recesses in the top of FIG. 2C shoe 41 so as to allow operation of screws 30 without “walking” across the bottom of socket 2 and without deforming it. During operation of screws 30, dog 22 is driven upward and away from plate 12 from sliding action between beveled faces of dog 22 and stationary plate 12 Thus, the vertical face of dog 22 is driven toward accessory 23. Therefore, within the confines of socket 2, plate 10, accessory 23, dog 22, and plate 12 are forced together, thus fastening accessory 23 inside socket 2.

While two screws 30 are shown, one may suffice. Because screw 30 operation places compressive force on itself during its operation, two are shown for added strength. FIG. 2 provides clamping pressure on accessory 23 at only one point, as opposed to the two widely spaced contact points provided by FIG. 1. In both FIG. 1 and FIG. 2 keeper 42 may be utilized, as may be a protruding cylindrical pin from the bottom of an accessory 23, for lateral positioning of accessory 23 through a hole in bottom side of socket 2, depending on the specific configuration of socket 2. Shoe 41 may be configured to accomplish the additional functions of positioning accessory 23, similar to keeper 42, while at the same time supporting screws 30. Shoe 41 is shown with its side adjacent the plate 12 as beveled to facilitate assembly of plate 12 into socket 2.

While FIG. 2 shows parts oriented one way with respect to vehicle socket 2, they may be oriented otherwise in any functional way. Also, plate 10 may be eliminated for some specific socket 2 configurations. The present invention includes the apparatus shown in FIG. 1 to include the accessory 23 being instead a receptacle, similar to that of a receptacle 40.

### Operation—FIGS. 3, 3A, 3B, 5A

FIG. 3 is cutaway view of a preferred embodiment of an assembly for joining accessories to a vehicle socket 2. Shown is an outside sheet metal body 1 of a vehicle, with integral socket 2 for joining accessories to the vehicle. A receptacle body 3 with a vertical hole through it holds accessories. Receptacle 3 is fastened to a FIG. 3A adapter plate 13 with screws 32. Adapter 13 is configured with a threaded hole in a side, here shown as oblique, to accept bolt 31 shown fastened through a FIG. 3B backing plate 15, for strength, and sheet metal body 1, thereby securely fastening all components to a vehicle socket 2. FIG. 5A shows a rectangular, flattened keeper 42 with a rectangular hole through it, which corresponds to the outside perimeter of an accessory member. The outside dimensions of keeper 42 are such that it will fit snugly within the bottom of a socket 2. FIG. 3 shows a keeper 42 within the bottom of socket 2 for insertion of any accessory bottom end for its certain lateral disposition. As keeper 42 outside dimensions are the same as socket 2 inside dimensions, keeper 42 precisely positions and holds an accessory. The oblique and adjacent faces of adapter plate 13 are depicted in just one selected configuration, but the entire side opposite the face adjoining receptacle 3 may be any configuration required to supportively fasten an adapter plate 13 inside a socket 2 cavity. All components of FIG. 1 are meant to fasten and align with a socket 2 such that an accessory may be securely installed vertically within receptacle 3 and through socket 2 access opening in a vehicle body 1.

FIG. 3A is a detail view of a selected configuration of an adapter plate 13, showing a threaded mounting hole in an oblique face, and two threaded holes through a top flange for fastening to receptacle 3. It spans the substantially useless voids found in some socket 2 cavities which disallow upright and secure fastening of accessories in sockets 2, and provides for secure fastening of receptacle 3 to a socket 2. The bolt 31 mounting hole may be on one or more surfaces of adapter 13 to suit different vehicle designs.

FIG. 3B shows a selected configuration flat backing plate 15 which in practice may be any shape whatsoever required by a specific vehicle to fasten a plate 15 to an adapter 13. While FIG. 3 shows invention parts oriented one selected way with respect to vehicle body 1, they may be otherwise oriented in any functional way.

### Operation—FIGS. 4, 4A, 4B

FIG. 4 shows an accessory connective assembly similar to that of FIG. 3 for joining accessories to vehicle sockets. FIG. 4A adapter 14 is configured to be fastened to a vehicle body 1 with multiple bolts through a FIG. 4B curved backing plate 16. The purpose of FIG. 4 is to show that some vehicles may require more than one mounting bolt 31 and one or more curved or straight backing plates 15 and/or 16, or otherwise configured as necessary, including fastening bolts 31 on more than one side of adapter 14. FIG. 4 provides for secure fastening of an accessory to a vehicle, similarly as FIG. 1. While FIG. 4 shows invention parts oriented one selected way with respect to vehicle body 1, they may be otherwise oriented in any functional way.

### Operation—FIGS. 5, 6

FIG. 5 is a detail view of a receptacle 3, with a vertical hole for holding an accessory. A top flange with two holes is for fastening receptacle 3 with an adapter, which in turn is fastened within a socket 2. Therefore, an accessory held in receptacle 3 will be fastened to a vehicle socket 2.

FIG. 6 shows a receptacle 4 with a vertical hole configured to hold an accessory, and enclose slidable clamping dogs 20 and 21, screw 30 and clamping plate 11, whose operation is described in FIG. 1. Thus, FIG. 6 fastens an accessory within the receptacle 4 vertical void. When fastened to an adapter, such as adapter 13, receptacle 4 fastens an accessory to a vehicle socket 2.

### Operation—FIGS. 7, 7A

FIG. 7 is an exploded view showing a receptacle body 3 with an accessory clamping yoke 43 operated by two yoke clamping screws 34. After insertion of an accessory into the receptacle 3 void, clamping yoke 43 may be clamped against an accessory to firmly hold it in the receptacle 3 by operation of screws 34, which fasten into respective holes in an adapter 13, or similar; therefore fastening an accessory to a vehicle. FIG. 7A is a detail opposite view of an alternative yoke 43 having threaded holes for cooperation with screws 34 inserted through receptacle 3 and an adapter from the opposite direction shown in FIG. 7.

### Operation—FIGS. 8, 9

FIG. 8 is a partially exploded view of a preferred embodiment of an assembly for joining an accessory to a vehicle socket 2. A vertical void through a receptacle 5 is for holding accessories. Receptacle 5 is configured with slidable, vertical ways which interlock with those of an adapter 17. A locking disc 44 is fastened to the adapter 17 with a screw 35 to prohibit receptacle 5 from vertical movement with respect to adapter plate 17. While the back side of the adapter 17 is shown flat, it may be any shape whatsoever to provide secure fastening within any configuration of a socket 2. FIG. 9 is a detail view of adapter 17 showing a broken line back side to indicate the back side may be configured as required to conform to any shape of any socket 2 for fastening. Not shown is threaded mounting hole(s) in the back side of adapter 17 for fastening to any socket 2. Therefore, an accessory may be held in the void through receptacle 5 and be joined to a vehicle.

### Operation—FIG. 10

FIG. 10 is a preferred embodiment of an assembly for fastening an accessory to a vehicle socket. A receptacle 6 vertical void is for holding an accessory and to contain a top slidable dog 21, screw 30, clamping plate 11, and unseen bottom slidable dog 20, as described in FIG. 1, for clamping an accessory inside the void of receptacle 6. Receptacle 6 is configured with vertical ways which interlock with those of adapter 17. A screw 35 through a hole in a disc 44 is fastened into a threaded hole in the top of adapter 17 to lock adapter 17 and receptacle 6 together, vertically. The back side of adapter 17 may be any configuration whatsoever to make rigid contact and provide for fastening with any configuration of any socket 2. Therefore, after fastening adapter 17 within a socket 2, receptacle 6 may be installed vertically through a socket 2 access opening, vertically interlocking receptacle 6 with the interlocking ways of adapter 17. After fastening together receptacle 6 and adapter 17 with screw 35 and disc 44, and clamping an accessory in the receptacle 6 void, the accessory will be fastened in a vehicle socket 2.

### Operation—FIG. 11

FIG. 11 is an exploded view of a preferred embodiment of an assembly for holding and joining an accessory to a vehicle socket 2. An adaptive insert 45 is configured with an upper end to fit snugly inside the tubular bottom end of receptacle 40, and has a cylindrical, vertical protrusion from its bottom side for insertion through a hole in the bottom of vehicle sockets 2 so configured, which secures it laterally. Two holes are shown toward the top of receptacle 40 for fastening to an accessory, after which an accessory is fastened to a vehicle. The present invention includes the apparatus shown in FIG. 11 configured as being an integral part of a vehicle accessory.

### Operation—FIG. 12

FIG. 12 is an exploded view of a preferred embodiment of a connector for holding and joining an accessory to a vehicle socket 2. A receptacle 49 for holding an accessory has a projection on one side with a threaded mounting hole through it for fastening to the wall of a vehicle socket 2. While the projection face is shown flat, it may be any required shape to conform to a wall of any socket 2. Alternatively, the projecting portion may be a separate adapter plate to accommodate installation of receptacle 49 in certain configurations of vehicle sockets 2. An adaptive insert 45 is configured with an upper end to fit snugly inside the tubular bottom end of receptacle 49, and has a cylindrical, vertical protrusion from its bottom side for insertion through a hole in the bottom of vehicle sockets 2 so configured, which secures it laterally. A hole toward the top of receptacle 49 is for possible fastening of an accessory, after which the accessory will be fastened to a vehicle. The present invention includes the apparatus shown in FIG. 12 configured as being an integral part of a vehicle accessory.

### Operation—FIG. 12A

FIG. 12A is an exploded view of a preferred embodiment of a connector for holding and fastening an accessory to a vehicle socket 2. A projection on one side of a receptacle 50 has a threaded mounting hole through it for fastening the receptacle 50 to the wall of a vehicle socket 2. Whereas the projection face is shown flat, it may be any shape whatsoever to conform to any wall of a socket 2. Alternatively, the projecting portion may be a separate adapter plate to accommodate installation of receptacle 50 in certain configurations of vehicle sockets 2. An adaptive keeper 42 is shown below receptacle 50, for snug placement in the bottom of a socket 2. The bottom of receptacle 50 is placed snugly in the hole through keeper 42 to secure it from lateral movement within the socket 2. Therefore, with installation of a mounting bolt 31 into the threaded hole in receptacle 50 to fasten it to a wall of a socket 2, receptacle 50 is held rigidly to a vehicle. A hole toward the top of receptacle 50 is for fastening an accessory, thereby fastening the accessory to a vehicle. The present invention includes the apparatus shown in FIG. 12A configured as being an integral part of a vehicle accessory.

### Operation—FIG. 12B

FIG. 12B is a detail view of preferred embodiment of a connector for holding and joining an accessory to a vehicle socket 2. A projection on one side of a receptacle 47 has a threaded mounting hole through it for fastening to a wall of a vehicle socket 2. Whereas the face of the projection is shown flat, it may be any shape whatsoever to conform to any wall of a socket 2. Alternatively, the projecting portion may be a separate adapter plate to accommodate installation of receptacle 47 in certain configurations of vehicle sockets 2. A vertical, cylindrical protrusion from the bottom of connector 47 is for insertion through a hole in the bottom of sockets 2 so configured, for prohibiting lateral movement of connector 47. A hole at the top of connector 47 is for fastening an accessory, after which the accessory will be fastened to a vehicle. The present invention includes the apparatus shown in FIG. 12B configured as being an integral part of a vehicle accessory.

### Operation—FIG. 13

FIG. 13 shows a typical embodiment of a connector for holding and joining an accessory to a vehicle socket 2. A connector 48 is configured with a horizontally threaded mounting hole in one side, and a cylindrical pin projecting vertically from its bottom end. After fastening connector 48 with a mounting bolt 31 through a socket 2 wall, and after insertion of the bottom pin through a hole in the bottom of a socket 2, connector 48 is rigidly fastened in a socket 2. Holes at the top of connector 48 are for fastening an accessory, which will then fasten the accessory to a vehicle. The present invention includes the apparatus shown in FIG. 13 configured as being an integral part of a vehicle accessory.

### Operation—FIG. 13A

FIG. 13A is a detail view of a typical embodiment of a connector for fastening an accessory to a vehicle socket 2. A connector 46 is configured with a cylindrical, vertical projection from its bottom, which is for insertion through a hole in the bottom of sockets 2 which are so configured. Therefore, the bottom end of connector 46 is secured from lateral movement. Holes in the top of connector 46 are for fastening an accessory, thus fastening an accessory to a vehicle. The present invention includes the apparatus shown in FIG. 13A configured as being an integral part of a vehicle accessory.

### Operation—FIG. 13B

FIG. 13B is a detailed exploded view of a typical embodiment of a connector for holding and fastening an accessory to a vehicle socket 2. A connective receptacle 51 is configured with a threaded, horizontal mounting hole in one side for fastening to the wall of a socket 2. A three-sided adaptive keeper 54 is shown below the receptacle 51, whose outside perimeter fits snugly within the bottom of a socket 2. The keeper inside is configured to snugly fit around the bottom of receptacle 51. After fastening the receptacle 51 to the wall of a socket 2, the keeper 54 placed at the bottom of a socket 2 ensures rigid installation of receptacle 51. Alternatively, a keeper 42 may be provided for certain installations, and functions similarly as keeper 42, as described in FIG. 5A.

### Operation—FIG. 14

FIG. 14 is an exploded view of a preferred embodiment of an adjustable assembly for joining an accessory to a vehicle socket. A cruciform receptacle 55 has a hollow vertical portion for holding an accessory, and its two opposed lateral projections have vertically threaded holes through both. Adaptive stays 53 are flat, U-shaped elements configured with elongated fastening holes along each of two legs, for fastening with screws 36 to the respective threaded holes in the receptacle 55 projections. When fastened, one adapter 53 lies atop the other such that screws 36 pass though respective elongated holes of both for fastening into respective threaded holes in the receptacle 55. Adjustable stay 53 elongated holes provide for adjustment of stays 53 toward and away receptacle 55, as required, so as to fasten receptacle 55 within a vehicle socket 2 by causing the distal ends of adapter stays 53 to urge against opposite walls of any socket 2. While not shown, receptacle 55 may be fitted with an insert 45 for certain disposition within a socket 2. Alternatively, it may be supplied with a keeper 42 or 54 for certain disposition within a socket 2 bottom, as described in FIGS. 12A and 13B respectively, depending on the specific socket 2 bottom configuration. A hole toward the top of receptacle 55 are for fastening an accessory, thereby fastening it to a vehicle. The present invention includes the apparatus shown in FIG. 14 configured as being an integral part of a vehicle accessory.

### Operation—FIG. 14A

FIG. 14A is an exploded view of a preferred embodiment of an adjustable assembly for joining an accessory to a vehicle socket 2. A solid cruciform receptacle 52 is configured with opposed horizontal projections, each with a vertical, threaded fastening hole. Two mutually overlapping, U-shaped adjustable stays 53 are shown with an elongated fastening hole in each leg. Each adaptive stay 53 is adjustably fastened to receptacle 52 with screws 36 such that the distal ends of stays 53 urge against opposite sides of a socket 2 for upright fastening of receptacle 52 within a socket 2. While not shown, the bottom end of receptacle 52 may be configured with a cylindrical vertical projection for fastening in the bottom of sockets 2 configured with a hole through their bottoms, for certain disposition of the receptacle 52 in the socket 2 bottom. Alternatively, receptacle 52 may be provided with a keeper 42 or 54 for certain disposition with a socket 2 bottom, whose operation is described in FIGS. 12A and 13B respectively. Holes toward the top of receptacle 52 are for fastening an accessory, thus fastening the accessory to a vehicle. The present invention includes the apparatus shown in FIG. 14A configured as being an integral part of a vehicle accessory.

### SUMMARY, RAMIFICATIONS, AND SCOPE

Accordingly, the reader will see that the vehicle socket connections of this invention can be used on sockets of diverse design. Considering that essentially every vehicle model ever produced has different cargo socket configurations, to accommodate fastening accessories to such vehicles requires different configurations of sets of apparatus. Therefore, the present invention provides diverse sets of components to accommodate different socket designs.

Although the description above contains many specificities, these should not be construed as limiting the scope of the invention, but as merely providing illustrations of some of the presently preferred embodiments of this invention. For example, the shape, orientation and assortment of parts shown may be changed to suit particular socket designs. Some components shown may alternatively be placed in the open, inside a truck bed, for example, and supported by other members attached to the truck bed and/or its insides. Also, some parts shown inside a socket may be configured to extend outside the socket, and vice versa.

While constituents of this invention are shown primarily as separate components inside vehicle sockets, this invention also includes accessories configured with members substantially similar in purpose or form to constituents of this invention. Furthermore, any constituent of this invention, and any with somewhat comparable purpose or form, even if provided as integral to a vehicle, are part of this invention.

Thus the scope of the invention should be determined by the appended intent and their legal equivalents, rather then by the examples given.

I claim:

1. A method for joining an object to a vehicle cargo socket, including the steps of:
a. providing components for joining said object to said socket, including those which are installed within said socket, and
b. providing said components to include those which are joined to a wall of said socket, and
c. providing said components that may be joined with said object,
whereby said components include those which are installed and joined to said socket so as to join said object with said socket.

2. The method of claim 1 for joining an object to a vehicle cargo socket, wherein providing said components includes different sets of components configured to join said object with different configurations of said socket, whereby said collection provides for joining said object to different constructions of said socket.

3. The method of claim 2 for joining an object to a vehicle cargo socket, wherein providing a said set of components that does not fasten to or bear against a rim of an access opening in a vehicle outer body sheathing while joining said object to said socket, whereby said set of components does not rely on said rim of on access opening in a vehicle outer body sheathing for support of said object or said collection of components for joining said object to said vehicle socket, but rather only a wall of said socket.

4. The method of claim 2 for joining an object to a vehicle cargo socket, wherein providing said set of components includes clamping of said object within a wall of said socket, so as to join said object with said socket, whereby said object is clamped to a wall of said socket and is not required to be a specific configuration for fastening to said socket.

5. The method of claim 2 for joining an object to a vehicle cargo socket, wherein providing said set of components includes adjustable joining of said object to a said socket, including a said socket having uncertain dimensions, whereby a said object can be adjustably joined to different constructions of said sockets.

6. The method of claim 2 for joining an object to a vehicle cargo socket, wherein providing said set of components includes interlocking joining of said components for joining of said object with said socket, whereby said object is provided certain disposition within said socket.

7. A means for joining an accessory with a vehicle socket, comprising:
a. a holder for joining with said accessory, and
b. a means for joining said holder to a wall of said socket,
whereby said accessory is joined to said socket.

8. The means of claim 7 wherein an assembly for joining said accessory to said socket, comprises:
a. in a said socket which is presumed to be longitudinally vertical, a receptacle configured for holding said accessory, and
b. adjustable stays which certainly dispose and fasten said receptacle within said socket,
whereby said accessory may be joined to said socket with simultaneous operations of certain disposition and fastening of said receptacle to a wall of said socket, even in said sockets of uncertain dimensions.

9. The means of claim 7 wherein an assembly for joining said accessory to said socket, comprises:
a. in a said socket which is presumed to be longitudinally vertical, a receptacle configured with a longitudinal, vertical void for holding said accessory, and
b. an adapter for said receptacle, which is fastened to said socket, wherein said receptacle and said adapter are fastened together,
whereby said accessory may be joined to said vehicle socket of unspecified form.

10. The means of claim 7 wherein an assembly for joining said accessory to said socket, comprises:
a. in a said socket which is presumed to be longitudinally vertical, a screw whose smooth shank and head cooperate vertically through a smooth hole through a vertically slidable top dog having one vertical face and an opposite beveled face, and
b. a bottom vertically slidable dog having one vertical face and an opposite beveled face, and which has a vertically threaded hole through it for cooperation with threads of said screw, and
c. a vertical clamping plate against a wall of said socket, with two beveled faces on one side which cooperate with respective said beveled faces of said top slidable dog and said bottom slidable dog, and
d. a receptacle for holding said accessory is formed between the wall of said socket opposite said clamping plate, and the vertical faces of said top slidable dog and said bottom slidable dog,
whereby during operation of said screw, said top slidable dog and said bottom slidable dog are drawn toward one another such that their said beveled faces, in cooperation with the respective said beveled faces of said clamping plate, causes said top slidable dog an said bottom slidable dog to move away from said clamping plate and toward said accessory receptacle, wherein the vertical sides of both said top slidable dog and bottom slidable dog will be urged against said accessory, wherein within the confines of said socket walls, said clamping plate; said top slidable dog; said bottom slidable dog; and said accessory will be clamped together, thereby joining said accessory to said vehicle socket.

11. The means of claim 7 wherein an assembly for joining said accessory to said socket, comprises:
a. in a said socket which is presumed to be longitudinally vertical, a receptacle body configured with a longitudinal void through it for holding said accessory, and with a flange across the top of a flat side which is longer than said void, configured with holes for fastening said receptacle, and
b. an adapter with a flange across the top of a flat side which is longer than said void, configured with threaded fastening holes for fastening it together with said receptacle with screws through said receptacle fastening holes such that both said flat sides are fastened together, and the opposite side of unspecified form is configured with one or more threaded holes for fastening with bolts through holes in a wall of unspecified form of said socket,
whereby said receptacle will hold said accessory and be fastened to said adapter which is fastened to said socket, thereby joining said accessory to said vehicle socket.

12. The means of claim 11 wherein an assembly for joining said accessory to said socket, comprises:
a clamping element with fastening holes, adjacent the top of said void in said receptacle for holding said accessory, so as to continue said longitudinal void through said receptacle and said clamping element, whereby fastening screws placed through said fastening holes through said clamping element and said receptacle fastening holes and fastened in said threaded fastening holes in said adapter flange, provide clamping of said accessory between said element and said receptacle flange face, thereby fastening said accessory to said socket.

13. The means of claim 11 wherein an assembly for joining said accessory to said socket, comprises:
a. in a said socket presumed to be longitudinally vertical, within said receptacle body void for holding said accessory, a screw whose smooth shank and head cooperate vertically through a smooth hole through a vertically slidable top dog having one vertical face and an opposite beveled face, and
b. a bottom vertically slidable dog having one vertical face and an opposite beveled face, and which has a vertically threaded hole through it for cooperation with threads of said screw, and
c. a vertical clamping plate against a wall of said receptacle void, having two beveled faces on one side which cooperate with respective said beveled faces of said top slidable dog and said bottom slidable dog, and
d. a receptacle for holding said accessory is formed between the wall of said receptacle body void opposite said clamping plate, and the vertical faces of said tops slidable dog and said bottom slidable dog, whereby during operation of said screw, said top slidable dog and said bottom slidable dog are drawn toward one another such that their said beveled faces, in cooperation with the respective said beveled faces of said clamping plate, causes said top slidable dog and said bottom slidable dog to move away from said clamping plate and toward said accessory in said receptacle, wherein the vertical sides of both said top slidable dog and bottom slidable dog will be urged against said accessory, wherein within the confines of said receptacle void walls, said clamping plate; said top slidable dog; said bottom slidable dog; and said accessory will be clamped together, thereby joining said accessory to said vehicle socket.

14. The means of claim 7 wherein an assembly for joining said accessory to said socket, comprises:
a. in a said socket presumed to be longitudinally vertical, a receptacle body configured with a vertically longitudinal void through it for holding said accessory, and with an entire side configured with longitudinally interlocking ways, and
b. an adapter with an entire side configured with longitudinally interlocking ways, and with its opposite side of unspecified form configured with one or more threaded holes for fastening with bolts through holes in a wall of unspecified form of said socket, wherein said adapter may be fastened to a wall of said socket, and so the longitudinally interlocking ways of said receptacle may then be slid vertically downward to substantially interlock with the longitudinally interlocking ways of said adapter, wherein said adapter will be fastened to said socket and said receptacle for holding said accessory will be interlocked with said adapter, thereby joining said accessory to said vehicle socket of unspecified form.

15. A method for joining an accessory to a vehicle cargo socket, including the steps of:
a. providing apparatus to include forms which can be joined to a wall of said socket, and
b. providing said apparatus which can also be joined with said accessory,
whereby said accessory can be joined to said apparatus so as to be joined to said vehicle socket.

16. The method of claim 15 for joining an accessory to a vehicle cargo socket, to further include the steps of:
a. providing for clamping said apparatus to a wall of said socket, and
b. providing for clamping together said accessory and said apparatus,
whereby said accessory can be clamped together with said apparatus so as to be clamped to said vehicle socket.

17. The method of claim 15 for joining an accessory to a vehicle cargo socket, to further include the steps of:
a. providing some interlocking constituents of said apparatus, and
b. providing for fastening of said interlocking constituents to a wall of said socket, and
c. providing for joining of said accessory with said constituents,
whereby said accessory can be joined with said socket.

18. The method of claim 15 for joining an accessory to a vehicle cargo socket, to further include the steps of:
a. providing for adjustable positioning of said apparatus in said socket of unspecified construction, and
b. providing for adjustable fastening of said apparatus in said socket of unspecified construction, and
c. providing for joining of said accessory with said apparatus,
whereby said accessory can be joined with said socket of unspecified construction.

19. The method of claim 15 for joining an accessory to a vehicle cargo socket, to further include the steps of:
a. providing for clamping of said accessory within said apparatus, and
b. providing for joining of said apparatus to a wall of said socket having unspecified construction,
whereby said accessory can be joined with said socket of unspecified construction.
